(19) United States
(12) Patent Application Publication
(10) Pub. No.: US 2025/0229857 A1
(43) Pub. Date: Jul. 17, 2025

(54) CONTROL DEVICE AND SYSTEM

(71) Applicant: TOYOTA JIDOSHA KABUSHIKI KAISHA, Toyota-shi (JP)

(72) Inventors: Yasuyoshi HATANO, Nisshin-shi (JP); Daiki YOKOYAMA, Miyoshi-shi (JP)

(73) Assignee: TOYOTA JIDOSHA KABUSHIKI KAISHA, Toyota-shi (JP)

(21) Appl. No.: 18/905,574

(22) Filed: Oct. 3, 2024

(30) Foreign Application Priority Data
Jan. 11, 2024 (JP) 2024-002217

(51) Int. Cl. B62D 65/18; G05D 1/695; G05D 105/45

(52) U.S. Cl. CPC B62D 65/18; G05D 1/695; G05D 2105/45

(57) ABSTRACT

In a factory, a control device for controlling an operation of a moving body of at least a part of a plurality of types of moving bodies includes a first-type moving body and a second-type moving body having a time required for a process set in advance in a factory longer than that of the first-type moving body, wherein the control instruction creating unit creates a control instruction so as to adjust a distance between the moving body and the succeeding moving body in a process before entering the process set in advance, and the control instruction creating unit creates a control instruction so that a second distance that is an inter-moving-body distance in a case where the preceding moving body is the second-type moving body is larger than a first distance that is an inter-moving-body distance in a case where the preceding moving body is the first-type moving body.

### CROSS-REFERENCE TO RELATED APPLICATION

This application claims priority to Japanese Patent Application No. 2024-002217 filed on Jan. 11, 2024, incorporated herein by reference in its entirety.

### BACKGROUND

### 1. Technical Field

The present disclosure relates to a control device and a system.

### 2. Description of Related Art

Technology of driving a vehicle by unmanned driving in a manufacturing process of the vehicle is known (e.g., Japanese Unexamined Patent Application Publication (Translation of PCT Application) No. 2017-538619 (JP 2017-538619 A)).

### SUMMARY

In the manufacturing process of such vehicles, there are cases in which different types of vehicles may be intermixed, and transported while maintaining a predetermined inter-vehicle distance. However, even in the same process, time required therefor may be different depending on the type of the vehicle. When a vehicle regarding which the time required for the process is longer is followed by a vehicle regarding which the time required for the process is shorter, distance between the vehicle and the succeeding vehicle is crammed, which may cause the succeeding vehicle to stop or decelerate, thereby hindering transporting of the succeeding vehicle.

The present disclosure can be realized in the following aspects.

(1) According to an aspect of the present disclosure, there is provided a control device that, in a factory for manufacturing a plurality of types of moving bodies in a mixed manner, controls operation of at least part of the types of moving bodies. The control device includes a control instruction creating unit that creates a control instruction for instructing control content to a moving body that is an object of control. The types of moving bodies include a first-type moving body, and a second-type moving body of which time required for a process set in advance in the factory is longer than that of the first-type moving body.

The control instruction creating unit creates the control instruction so as to adjust an inter-moving-body distance between a preceding moving body and a succeeding moving body following the preceding moving body in a process before entering the process set in advance. The control instruction creating unit creates the control instruction such that a second distance that is the inter-moving-body distance when the preceding moving body is the second-type moving body, is greater than a first distance that is the inter-moving-body distance when the preceding moving body is the first-type moving body.

According to the control device of this aspect, the control instruction is created such that the second distance is greater than the first distance in the process before entering the process set in advance. The first distance is the inter-moving-body distance when the preceding moving body is the first-type moving body. The second distance is the inter-moving-body distance when the preceding moving body is the second-type moving body. Accordingly, a long time can be secured until the succeeding moving body enters the next process following the second-type moving body. Thus, the succeeding moving body can be suppressed from entering the next process before work for the second-type moving body in the next process is completed, and causing the succeeding moving body to stop or decelerate. As a result, traveling of the succeeding moving body can be suppressed from being hindered.

(2) According to another aspect of the present disclosure, there is provided a control device that, in a factory for manufacturing a plurality of types of moving bodies in a mixed manner, controls operation of at least part of the types of moving bodies.

The control device includes a control instruction creating unit that creates a control instruction for instructing control content to a moving body that is an object of control.

The types of moving bodies include a first-type moving body, and a second-type moving body of which time required for a process set in advance in the factory is longer than that of the first-type moving body.

The control instruction creating unit creates the control instruction so as to adjust an inter-moving-body distance between a preceding moving body and a succeeding moving body following the preceding moving body in a process before entering the process set in advance. The control instruction creating unit creates the control instruction such that a third distance that is the inter-moving-body distance when the succeeding moving body is the second-type moving body, is smaller than a first distance that is the inter-moving-body distance when the succeeding moving body is the first-type moving body.

According to the control device of this aspect, the control instruction is created such that the third distance is smaller than the first distance in the process before entering the process set in advance. The first distance is the inter-moving-body distance when the succeeding moving body is the first-type moving body. The third distance is the inter-moving-body distance when the succeeding moving body is the second-type moving body. Accordingly, the timing at which the second-type moving body enters the next process following the preceding moving body can be sped up, and hence a long time can be secured before the succeeding moving body enters the next process following the second-type moving body. Thus, the succeeding moving body can be suppressed from entering the next process before the work for the second-type moving body in the next process is completed, and causing the succeeding moving body to stop or decelerate, thereby suppressing traveling of the succeeding moving body from being hindered.

(3) In the above embodiment,
a type information acquisition unit that acquires type information, that is information regarding the type of the moving body, and
an identifying unit that uses the type information to identify a required process time that is time required for completing work set in advance for the moving body in the process set in advance,
may be further included, and
the control instruction creating unit may create the control instruction using the required process time.

According to the control device of this aspect, the type information is acquired, the required process time is identified by using the type information, and the control instruction is created using the required process time, and accordingly an appropriate control instruction can be generated in accordance with the required process time.

(4) According to another aspect of the present disclosure, there is provided a system that, in a factory for manufacturing a plurality of types of moving bodies in a mixed manner, controls operation of at least part of the types of moving bodies.

The system includes a control instruction creating unit that creates a control instruction for instructing control content to a moving body that is an object of control.

The types of moving bodies include a first-type moving body, and a second-type moving body of which time required for a process set in advance in the factory is longer than that of the first-type moving body.

The control instruction creating unit creates the control instruction so as to adjust an inter-moving-body distance between a preceding moving body and a succeeding moving body following the preceding moving body in a process before entering the process set in advance. The control instruction creating unit creates the control instruction such that a second distance that is the inter-moving-body distance when the preceding moving body is the second-type moving body, is greater than a first distance that is the inter-moving-body distance when the preceding moving body is the first-type moving body.

According to the system of this aspect, the control instruction is created such that the second distance is greater than the first distance in the process before entering the process set in advance. The first distance is the inter-moving-body distance when the preceding moving body is the first-type moving body. The second distance is the inter-moving-body distance when the preceding moving body is the second-type moving body. Accordingly, a long time can be secured until the succeeding moving body enters the next process following the second-type moving body. Thus, the succeeding moving body can be suppressed from entering the next process before work for the second-type moving body in the next process is completed, and causing the succeeding moving body to stop or decelerate. As a result, traveling of the succeeding moving body can be suppressed from being hindered.

(5) According to another aspect of the present disclosure, there is provided a control method for, in a factory for manufacturing a plurality of types of moving bodies in a mixed manner, controlling operation of at least part of the types of moving bodies.

The types of moving bodies include a first-type moving body, and a second-type moving body of which time required for a process set in advance in the factory is longer than that of the first-type moving body.

This control method includes creating a control instruction for instructing control content to a moving body that is an object of control, so as to adjust an inter-moving-body distance between a preceding moving body and a succeeding moving body following the preceding moving body in a process before entering the process set in advance, and
creating the control instruction such that a second distance that is the inter-moving-body distance when the preceding moving body is the second-type moving body, is greater than a first distance that is the inter-moving-body distance when the preceding moving body is the first-type moving body.

According to the control method of this aspect, the control instruction is created such that the second distance is greater than the first distance in the process before entering the process set in advance. The first distance is the inter-moving-body distance when the preceding moving body is the first-type moving body. The second distance is the inter-moving-body distance when the preceding moving body is the second-type moving body. Accordingly, a long time can be secured until the succeeding moving body enters the next process following the second-type moving body. Thus, the succeeding moving body can be suppressed from entering the next process before work for the second-type moving body in the next process is completed, and causing the succeeding moving body to stop or decelerate. As a result, traveling of the succeeding moving body can be suppressed from being hindered.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a configuration of a system according to a first embodiment;

FIG. 2 is a block diagram illustrating a configuration of the system according to the first embodiment;

FIG. 3 is a flowchart illustrating a processing procedure of travel control of the vehicle according to the first embodiment;

FIG. 4 is a flowchart illustrating a procedure of a control instruction creation process according to the first embodiment;

FIG. 5 is an explanatory diagram illustrating a first example of the control instruction creation process;

FIG. 6 is an explanatory diagram illustrating a second example of the control instruction creation process;

FIG. 7 is a block-diagram illustrating a configuration of a system according to a second embodiment; and

FIG. 8 is a flowchart illustrating a processing procedure of travel control of the vehicle according to the second embodiment.

### DETAILED DESCRIPTION OF EMBODIMENTS

### A. First Embodiment

### A-1. System Configuration:

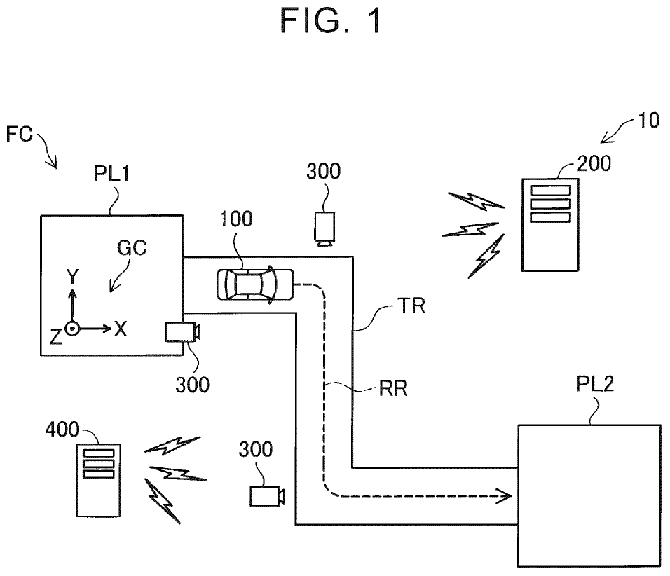

FIG. 1 is a conceptual diagram illustrating a configuration of a system 10 according to a first embodiment. The system 10 includes one or more vehicles 100 serving as a moving body, a server 200, one or more external sensors 300, and a process management device 400 that manages manufacturing of the vehicles 100 in a factory.

In the present disclosure, “moving body” means a movable object, and is, for example, a vehicle or an electric vertical takeoff and landing machine (a so-called flying vehicle). The vehicle may be a vehicle traveling by a wheel or a vehicle traveling by an infinite track, and is, for example, a passenger car, a truck, a bus, a two-wheeled vehicle, a four-wheeled vehicle, a tank, a construction vehicle, or the like. Vehicles include battery electric vehicle (BEV), gasoline-powered vehicles, hybrid electric vehicle, and fuel cell electric vehicle. When the moving body is other than the vehicle, the expressions of “vehicle” and “vehicle” in the present disclosure can be appropriately replaced with “moving body”, and the expression of “traveling” can be appropriately replaced with “moving”.

The vehicle 100 is configured to be able to travel by unmanned driving. The term “unmanned driving” means driving that does not depend on the traveling operation of the passenger. The traveling operation means an operation related to at least one of “running”, “turning”, and “stopping” of the vehicle 100. The unmanned driving is realized by automatic or manual remote control using a device located outside the vehicle 100 or by autonomous control of the vehicle 100. A passenger who does not perform the traveling operation may be on the vehicle 100 traveling by the unmanned driving. The passenger who does not perform the traveling operation includes, for example, a person who is simply seated on the seat of the vehicle 100 and a person who performs a work different from the traveling operation such as an assembling operation, an inspection operation, and an operation of switches while riding on the vehicle 100. Driving by the traveling operation of the occupant is sometimes referred to as “manned driving”.

Herein, “remote control” includes “full remote control” in which all of the operations of the vehicle 100 are completely determined from the outside of the vehicle 100, and “partial remote control” in which a part of the operations of the vehicle 100 is determined from the outside of the vehicle 100. Also, “autonomous control” includes “full autonomous control” and “partial autonomous control”. Further, in the “complete autonomous control”, the vehicle 100 autonomously controls its own operation without receiving any information from a device outside the vehicle 100. In “partial autonomous control”, the vehicle 100 autonomously controls its own operation using information received from a device outside the vehicle 100. In the following description, control for traveling of the vehicle 100 realized by remote control or autonomous control is also referred to as “traveling control”. The travel control corresponds to “movement control” in the present disclosure.

In the present embodiment, the system 10 is used in a factory FC for manufacturing the vehicles 100. The reference coordinate system of the factory FC is a global coordinate system GC. That is, any position in the factory FC is represented by the coordinates of X, Y, Z in the global coordinate system GC. The factory FC includes a first location PL1 and a second location PL2. The first location PL1 and the second location PL2 are connected by a traveling road TR on which the vehicles 100 can travel. In the factory FC, a plurality of external sensors 300 are installed along the traveling road TR. The positions of the external sensors 300 in the factory FC are adjusted in advance. The vehicles 100 travel through the traveling road TR from the first location PL1 to the second location PL2 by unmanned driving.

The external sensor 300 is a sensor located outside the vehicle 100, and acquires information related to the vehicle 100. The external sensor 300 in the present embodiment is a sensor that captures the vehicle 100 from the outside of the vehicle 100. Specifically, the external sensor 300 is constituted by a camera. The camera as the external sensor 300 captures a captured image including the vehicle 100, and outputs the captured image as a detection result. The external sensor 300 includes a communication device (not shown), and can communicate with another device such as the server 200 by wired communication or wireless communication.

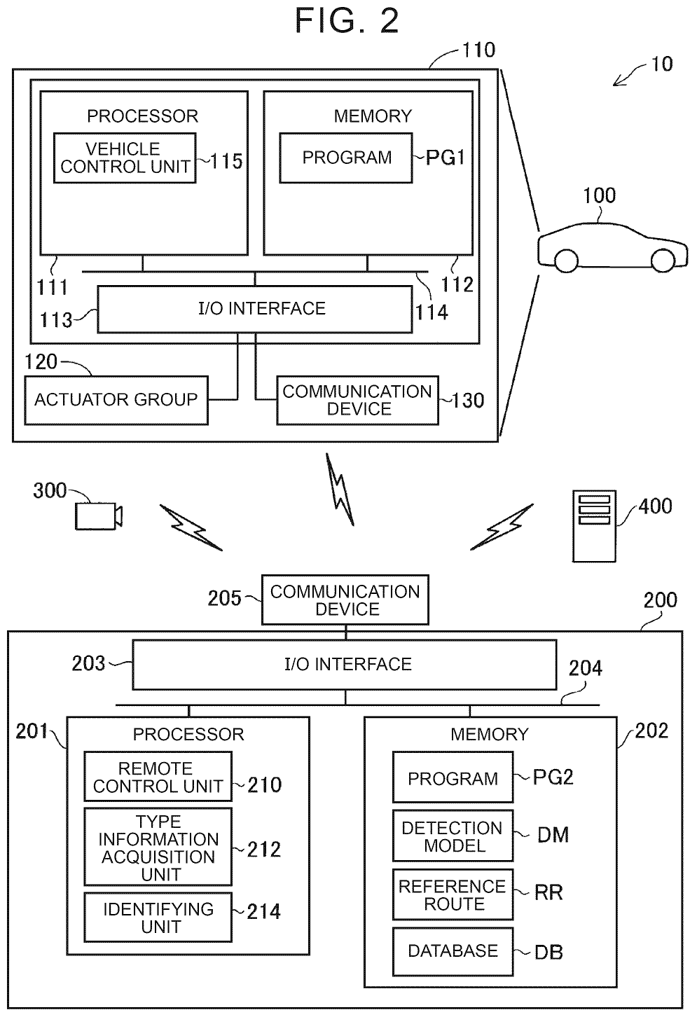

FIG. 2 is a block diagram illustrating a configuration of the system 10 according to the first embodiment. The vehicle 100 includes a vehicle control device 110, an actuator group 120, and a communication device 130. The vehicle control device 110 is configured to control each unit of the vehicle 100. The actuator group 120 includes one or more actuators driven under the control of the vehicle control device 110. The communication device 130 is configured to communicate with an external device such as the server 200 by wireless communication. The actuator group 120 includes an actuator of a driving device for accelerating the vehicle 100, an actuator of a steering device for changing a traveling direction of the vehicle 100, and an actuator of a braking device for decelerating the vehicle 100. In addition, the vehicle 100 may include various sensors (not shown) such as a vehicle speed sensor and a yaw rate sensor.

The vehicle control device 110 includes a computer including a processor 111, a memory 112, an input/output interface 113, and an internal bus 114. The processor 111, the memory 112, and the input/output interface 113 are bidirectionally communicably connected via an internal bus 114. An actuator group 120 and a communication device 130 are connected to the input/output interface 113. The processor 111 executes the program PG1 stored in the memory 112 to realize various functions including functions as the vehicle control unit 115.

The vehicle control unit 115 controls the actuator group 120 to cause the vehicle 100 to travel. The vehicle control unit 115 can cause the vehicle 100 to travel by controlling the actuator group 120 using the travel control signal received from the server 200. The travel control signal is a control signal for causing the vehicle 100 to travel. In the present embodiment, the travel control signal includes the acceleration and the steering angle of the vehicle 100 as parameters. In other embodiments, the travel control signal may include the speed of the vehicle 100 as a parameter in place of or in addition to the acceleration of the vehicle 100.

The server 200 includes a computer including a processor 201, a memory 202, an input/output interface 203, and an internal bus 204. The processor 201, the memory 202, and the input/output interface 203 are bidirectionally communicably connected via an internal bus 204. A communication device 205 for communicating with various devices external to the server 200 is connected to the input/output interface 203. The communication device 205 can communicate with the vehicle 100 by wireless communication, and can communicate with each of the external sensors 300 and the process management device 400 by wired communication or wireless communication. The server 200 corresponds to a “control device” in the present disclosure.

The processor 201 implements various functions including functions as the remote control unit 210 by executing the program PG2 stored in the memory 202. In the present embodiment, the processor 201 functions as a remote control unit 210, a type information acquisition unit 212, and an identifying unit 214.

The remote control unit 210 acquires a detection result by the sensor. The remote control unit 210 uses the detection result to generate a travel control signal for instructing the control content of the actuator group 120 of the vehicle 100. The remote control unit 210 transmits a travel control signal to the vehicle 100 to cause the vehicle 100 to travel by remote control. The procedure of the travel control realized by the remote control of the present embodiment will be described later. The remote control unit 210 may generate and output not only a travel control signal but also a control signal for controlling various accessories provided in the vehicle 100 and actuators for operating various kinds of equipment such as a wiper, a power window, and a lamp. That is, the remote control unit 210 may operate the various types of equipment and the various accessories by remote control. In the following description, the travel control signal is also referred to as a “control instruction”. The remote control unit 210 corresponds to a “control instruction creating unit” in the present disclosure.

The type information acquisition unit 212 acquires information indicating the type of the vehicle 100 to be controlled (hereinafter, also referred to as “type information”). The “type of vehicle 100” means an ID for identifying each vehicle 100 or an attribute to which the vehicle 100 belongs, such as a vehicle type and a shipping destination of the vehicle 100.

The identifying unit 214 identifies the time required for the process. The “process time required” means a time required for a process set in advance in the manufacturing line, more specifically, a time required for the vehicle 100 to complete the work performed on the vehicle 100 in the process after entering the process. Even in the same process, the contents of the work to be executed may differ depending on the type of the vehicle 100, and therefore, the time required for the process may differ depending on the type of the vehicle 100. In the present embodiment, the required process times are set in advance for each type and each process of the vehicles 100, and are associated with each other as a database DB and stored in advance in the memories 202. Note that the “process” is not limited to the component attaching process to the vehicle 100 in the middle of manufacturing, and means an arbitrary process performed until shipment of the vehicle 100, such as an inspection process for the completed vehicle and a power feeding process performed when the completed vehicle is conveyed to the yard.

The process management device 400 is a device for managing a manufacturing process of the vehicle 100. The process management device 400 is constituted by a computer. The process management device 400 acquires information from various facilities of the factory FC, generates information on a manufacturing process of the vehicle 100 as a product, and manages the information for each vehicle 100. In the following description, information regarding a manufacturing process of a product is referred to as process information. In the present embodiment, the process information includes information indicating when, where, and which worker is scheduled to perform what work on which product. The process information includes information indicating when, where, which worker, which product, and what work was performed. The process information includes information indicating the progress status of the work. The process management device 400 includes a communication device (not shown), and transmits process information to the server 200 through wired communication or wireless communication. Note that the function of the process management device 400 may be implemented in the same apparatus as the server 200. In addition, the system 10 may not include the process management device 400.

### A-2. Drive Control:

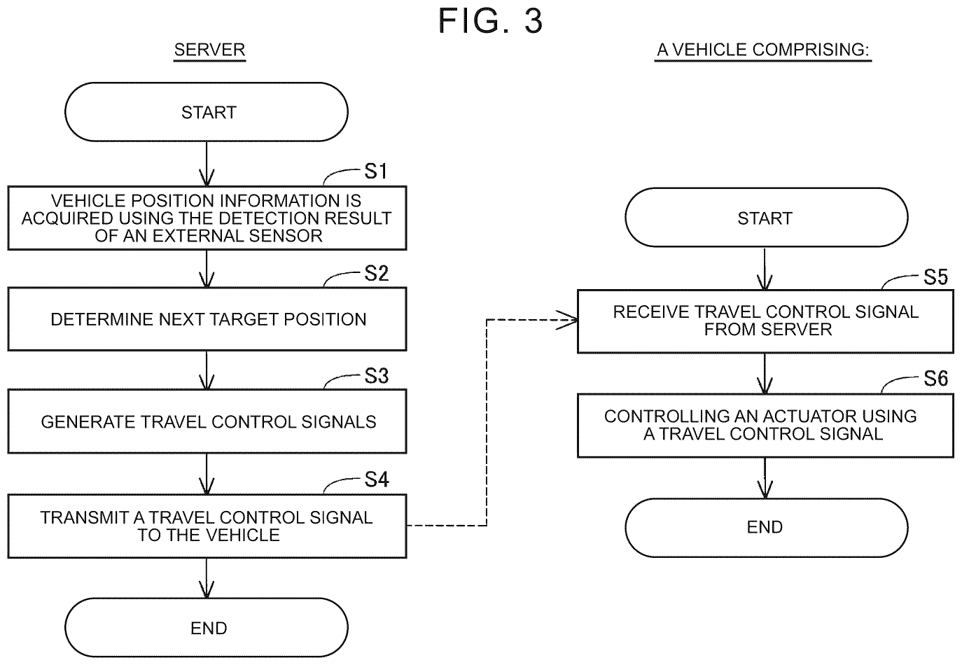

FIG. 3 is a flowchart illustrating a processing procedure of travel control of the vehicle 100 according to the first embodiment. In S1, the remote control unit 210 acquires the vehicle position data of the vehicle 100 using the detection data outputted from the external sensor 300. The vehicle position information is position information that is a basis for generating a travel control signal. In the present embodiment, the vehicle position information includes the position and orientation of the vehicle 100 in the global coordinate system GC of the factory FC. Specifically, in S1, the remote control unit 210 acquires the vehicle position data using the captured images acquired from the cameras that are the external sensors 300.

Specifically, in S1, the remote control unit 210 detects the external shape of the vehicle 100 from the captured images, for example. The remote control unit 210 calculates the coordinates of the positioning point of the vehicle 100 in the coordinate system of the captured image, that is, the local coordinate system. The remote control unit 210 acquires the position of the vehicle 100 by converting the calculated coordinates into coordinates in the global coordinate system GC. The outline of the vehicle 100 included in the captured image can be detected by, for example, inputting the captured image into a detection-model DM using artificial intelligence. The detection model DM is prepared in the system 10 or outside the system 10, for example, and stored in the memory 202 of the server 200 in advance. The detection model DM may be, for example, a learned machine learning model learned to implement either semantic segmentation or instance segmentation. As the machine learning model, for example, a convolutional neural network (hereinafter, CNN) learned by supervised learning using a learning dataset can be used. The training data set includes, for example, a plurality of training images including the vehicle 100 and a label indicating which of the regions in the training image indicates the vehicle 100 and the regions other than the vehicle 100. When CNN is learned, the parameters of CNN are preferably updated by back propagation so as to reduce the error between the output-result and -label due to the detection model DM. The remote control unit 210 uses, for example, an optical flow method. The remote control unit 210 estimates the direction of the vehicle 100 based on the direction of the movement vector of the vehicle 100 calculated from the position change of the feature point of the vehicle 100 between the frames of the captured image. Thus, the remote control unit 210 can acquire the direction of the vehicle 100.

In S2, the remote control unit 210 determines a target position to which the vehicle 100 is to be directed next. In the present embodiment, the target position is represented by the coordinates of X, Y, Z in the global coordinate system GC. In the memory 202 of the server 200, reference route RR that is a route on which the vehicle 100 should travel is stored in advance. The route is represented by a node indicating a starting point, a node indicating a passing point, a node indicating a destination, and a link connecting the respective nodes. The remote control unit 210 uses the vehicle position information and the reference route RR to determine a target position to which the vehicle 100 is to be directed next. The remote control unit 210 determines the target position on the reference route RR ahead of the current position of the vehicle 100.

At S3, the remote control unit 210 generates a travel control signal for causing the vehicle 100 to travel toward the determined target position. The remote control unit 210 calculates the traveling speed of the vehicle 100 from the transition of the position of the vehicle 100, and compares the calculated traveling speed with the target speed. As a whole, the remote control unit 210 determines the acceleration so that the vehicle 100 accelerates when the traveling speed is lower than the target speed, and determines the acceleration so that the vehicle 100 decelerates when the traveling speed is higher than the target speed. When the vehicle 100 is located on the reference route RR, the remote control unit 210 determines the steering angle and the acceleration so that the vehicle 100 does not deviate from the reference route RR. When the vehicle 100 is not located on the reference route RR, in other words, when the vehicle 100 deviates from the reference route RR, the remote control unit 210 determines the steering angle and the acceleration so that the vehicle 100 returns to the reference route RR.

At S4, the remote control unit 210 transmits the generated travel control signal to the vehicles 100. The remote control unit 210 repeats the acquisition of the position of the vehicle 100, the determination of the target position, the generation of the travel control signal, the transmission of the travel control signal, and the like at predetermined intervals.

In S5, the vehicle control unit 115 receives the travel control signal transmitted from the server 200. In S6, the vehicle control unit 115 controls the actuator group 120 using the received travel control signal, thereby causing the vehicle 100 to travel at the acceleration and the steering angle represented by the travel control signal. The vehicle control unit 115 repeats the reception of the travel control signal and the control of the actuator group 120 at a predetermined cycle. According to the system 10 of the present embodiment, the vehicle 100 can be driven by remote control, and the vehicle 100 can be moved without using a conveyance facility such as a crane or a conveyor.

### A-3. Control Instruction Creation Process:

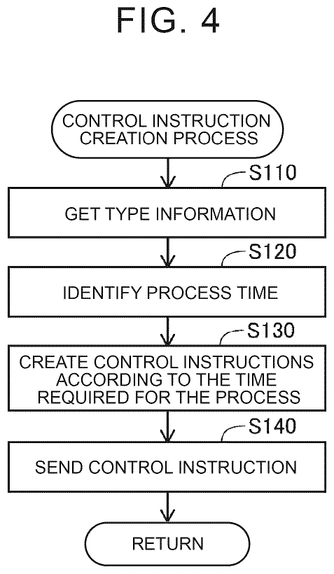

FIG. 4 is a flowchart illustrating a procedure of a control instruction creating process according to the first embodiment. In the present embodiment, the above-described travel control is executed as the basic control, and the present processing is executed in combination with the travel control.

In S110, the type information acquisition unit 212 acquires the type information of the vehicle 100 and identifies the type of the vehicle 100. In the present embodiment, the type information acquisition unit 212 acquires the captured image acquired by the external sensor 300 as the type information, and identifies the type of the vehicle 100 by using the captured image. The type of the vehicle 100 included in the captured image can be acquired by, for example, inputting the captured image into a classification model utilizing artificial intelligence. The classification model is prepared in the system 10 or outside the system 10, for example, and stored in the memory 202 of the server 200 in advance. Examples of the classification model include a learned machine learning model in which the vehicle type of the vehicle 100 included in the captured image is learned so as to be distinguishable. As the machine learning model, for example, a CNN learned by supervised learning using a learning dataset can be used. The training data set includes, for example, a plurality of training images including the vehicle 100 and a label indicating the vehicle type of the vehicle 100 included in the training images.

In S120, the identifying unit 214 identifies the required process time of the vehicle 100 in the next process using the identified type of the vehicle 100. In the present embodiment, the identifying unit 214 identifies the next process of the vehicle 100 by using the process information about the vehicle 100 acquired from the process management device 400, and identifies the required process time in the next process of the vehicle 100 by referring to the above-described database DB. The identifying unit 214 may identify the next process of the vehicle 100 based on the position of the vehicle 100 identified by using the captured image acquired from the external sensor 300.

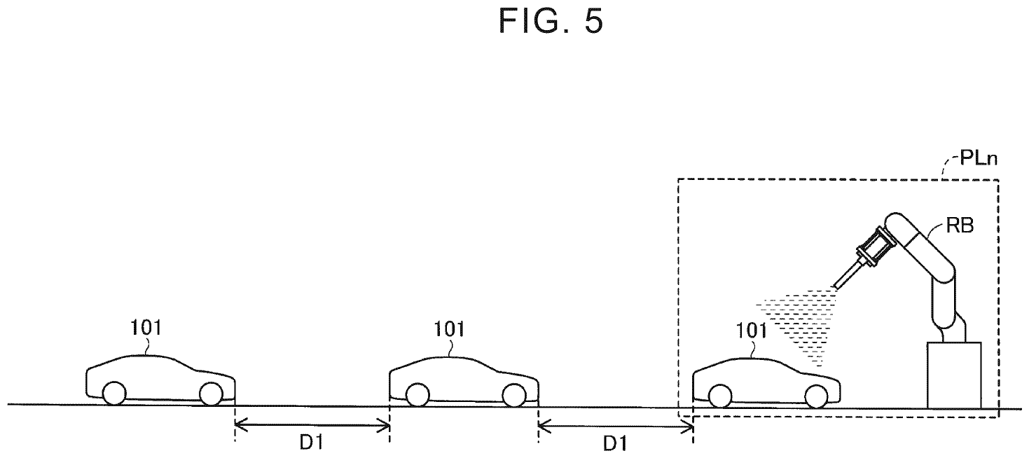

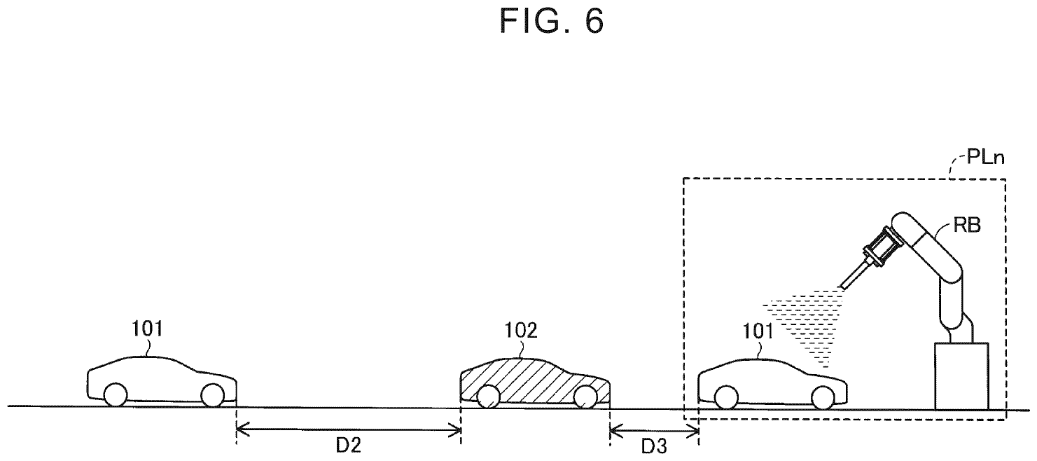

In S130, the remote control unit 210 creates a control instruction in accordance with the identified process time-required. The processing in this process will be described more specifically with reference to FIG. 5 and FIG. 6. FIG. 5 is an explanatory diagram illustrating a first example of a control instruction creation process. FIG. 6 is an explanatory diagram illustrating a second example of the control instruction creation process. FIG. 5 and FIG. 6 exemplify, as the next process PLn, a water leakage test in which a liquid or a gas is jetted to the vehicles 100 by a robotic RB. In FIG. 5 and FIG. 6, a first-type vehicle 101 and a second-type vehicle 102 indicated by hatching are shown. The types of the first-type vehicle 101 and the second-type vehicle 102 are different from each other. Further, the process required time of the second-type vehicle 102 in the next process PLn is longer than the process required time of the first-type vehicle 101 in the next process PLn. The first-type vehicle 101 corresponds to the “first-type moving body” in the present disclosure, and the second-type vehicle 102 corresponds to the “second-type moving body” in the present disclosure.

As shown in FIG. 5, when a plurality of first-type vehicles 101 are transported, the remote control unit 210 creates a control instruction for each first-type vehicle 101 so that the inter-vehicle distance between the first-type vehicles 101 becomes the distance D1. The distance D1 corresponds to the “first distance” in the present disclosure. The “inter-vehicle distance” corresponds to the “inter-moving-body distance” in the present disclosure.

On the other hand, as shown in FIG. 6, the first-type vehicle 101 and the second-type vehicle 102 may travel in a mixed manner. In this case, the remote control unit 210 creates a control instruction for the second-type vehicle 102 so that the inter-vehicle distance between the first-type vehicle 101 and the second-type vehicle 102 located behind the second-type vehicle 102 is the distance D2. The distance D2 is greater than the distance D1. Hereinafter, the first-type vehicle 101 located behind the second-type vehicle 102 is also referred to as a “succeeding vehicle”. More specifically, the remote control unit 210 creates a control instruction that instructs the second-type vehicle 102 to travel at a speed higher than that of the succeeding vehicle. The “succeeding vehicle” corresponds to the “succeeding moving body” in the present disclosure. The distance D2 is set in advance in accordance with the time required for the process of the second-type vehicles 102 in the next process PLn, and corresponds to the “second distance” in the present disclosure. Accordingly, it is possible to secure a long period of time after the second-type vehicle 102 enters the next process PLn and before the succeeding vehicle enters the next process PLn following the second-type vehicle 102. That is, before the operation for the second-type vehicle 102 in the next process PLn is completed, the succeeding vehicle enters the next process PLn, and the succeeding vehicle can be prevented from stopping or decelerating, and the traveling of the succeeding vehicle can be prevented from being prevented.

Further, the inter-vehicle distance between the first-type vehicle 101 (hereinafter, also referred to as “preceding vehicle”) located in front of the second-type vehicle 102 and the second-type vehicle 102 is a distance D3 smaller than the distance D1. The distance D3 corresponds to the “third distance” in the present disclosure. The “preceding vehicle” corresponds to the “preceding moving bodies” in the present disclosure. As a result, the timing at which the second-type vehicle 102 enters the next process PLn following the preceding vehicle can be accelerated, so that the time until the succeeding vehicle enters the next process PLn following the second-type vehicle 102 can be secured for a long time. Accordingly, it is possible to prevent the succeeding vehicle from entering the next process PLn and stopping or decelerating before the operation on the second-type vehicle 102 in the next process PLn is completed, and to prevent the succeeding vehicle from being prevented from traveling.

In S140, the remote control unit 210 transmits the created control instruction to the vehicles 100.

According to the system 10 of the embodiment described above, prior to entering the next process PLn, a control instruction is created so that the distance D2 is larger than the distance D1. The distance D1 is a distance between the first-type vehicle 101 and a succeeding vehicle of the first-type vehicle 101. The distance D2 is a distance between the second-type vehicle 102 and a succeeding vehicle of the second-type vehicle 102. Therefore, it is possible to secure a long period of time until the succeeding vehicle enters the next process PLn following the second-type vehicle 102. Accordingly, it is possible to prevent the succeeding vehicle from entering the next process PLn and stopping or decelerating the succeeding vehicle before the operation for the second-type vehicle 102 in the next process PLn is completed. As a result, it is possible to prevent the traveling of the succeeding vehicle from being disturbed.

Further, prior to entering the next process PLn, a control instruction is created so that the distance D3 is smaller than the distance D1. The distance D1 is a distance between the first-type vehicle 101 and the preceding vehicle of the first-type vehicle 101. The distance D3 is a distance between the second-type vehicle 102 and the preceding vehicle of the second-type vehicle 102. Therefore, since the timing at which the second-type vehicle 102 enters the next process PLn following the preceding vehicle can be advanced, it is possible to secure a long time until the succeeding vehicle enters the next process PLn following the second-type vehicle 102. As a result, it is possible to prevent the succeeding process from entering the next process PLn prior to the completion of the operation on the second-type vehicles 102 in the next process PLn, and to prevent the succeeding process from being stopped or decelerated, and to prevent the subsequent travel from being prevented.

Further, since the type information is acquired, the time required for the process is identified by using the type information, and the control instruction is created by using the time required for the process, an appropriate control instruction can be created according to the time required for the process.

### B. Second Embodiment

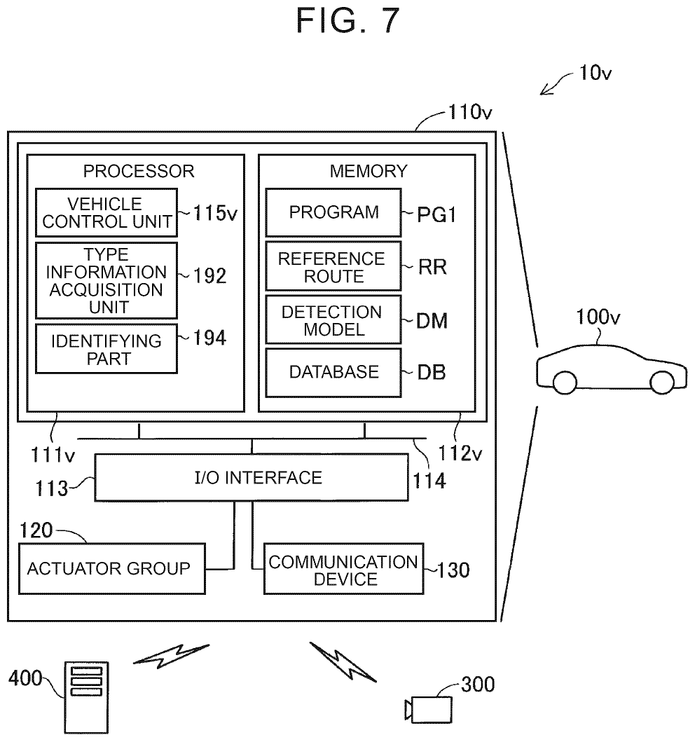

FIG. 7 is a block-diagram illustrating a configuration of a system 10v according to the second embodiment. This embodiment differs from the first embodiment in that the system 10v does not include the servers 200. Further, the vehicle 100v according to the present embodiment can travel by autonomous control of the vehicle 100v. Other configurations are the same as those of the first embodiment unless otherwise described.

In the present embodiment, the processor 111v of the vehicle control device 110v functions as the vehicle control unit 115v, the type information acquisition unit 192, and the identifying unit 194 by executing the program PG1 stored in the memory 112v. The vehicle control unit 115v can cause the vehicle 100v to travel by autonomous control by acquiring a detection result by the sensor, generating a travel control signal using the detection result, and outputting the generated travel control signal to operate the actuator group 120. The vehicle control unit 115v in the second embodiment corresponds to a “control instruction creating unit” in the present disclosure. In the present embodiment, in addition to the program PG1, the detection model DM, the reference route RR, and the database DB are stored in advance in the memory 112v. The vehicle control device 110v according to the second embodiment corresponds to a “control device” according to the present disclosure.

In the present embodiment, the type information acquisition unit 192 may identify its own type by using the captured image as in the first embodiment. Alternatively, the type information acquisition unit 192 may acquire the type information by previously storing the type information indicating the type in the memory 112v and acquiring the type information.

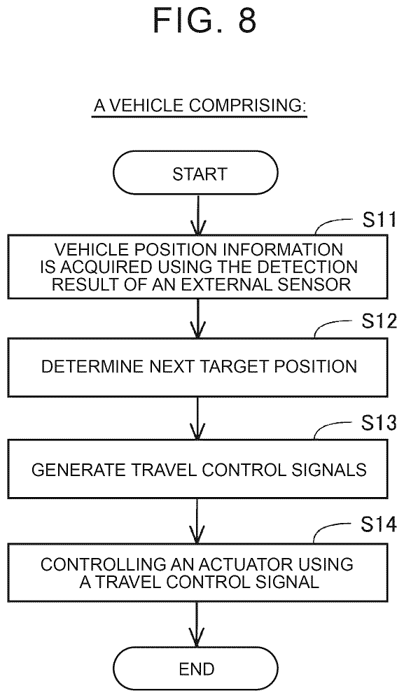

FIG. 8 is a flow chart showing a process sequence of travel control of the vehicle 100v according to the second embodiment. In S11, the processor 111v acquires the position information of the vehicle by using the detection result outputted from the camera which is the external sensor 300. In S11 according to the present embodiment, the processor 111v acquires the vehicle position data using the captured images and the vehicle speed as in S1 of FIG. 3. In S12, the processor 111v determines the target position to which the vehicle 100v should be headed next. In S13, the processor 111v generates a travel control signal for causing the vehicle 100v to travel toward the determined target position. In S14, the processor 111v controls the actuator group 120 by using the generated travel control signal, thereby causing the vehicle 100v to travel in accordance with the parameter represented by the travel control signal. The processor 111v repeats acquiring the vehicle position information, determining the target position, generating the travel control signal, and controlling the actuator group 120 at a predetermined cycle. According to the system 10v of the present embodiment, the vehicle 100v can be driven by the autonomous control of the vehicle 100v without remotely controlling the vehicle 100v by the servers 200.

### C. Other Embodiments

(C1) In the above-described embodiment, the identifying unit 214 identifies the process time required for the vehicle 100 in the next process in S120 illustrated in FIG. 4, and in S130, creates a control instruction for the vehicle 100 in accordance with the process time required, but the present disclosure is not limited thereto. The identifying unit 214 may identify a required time for a process of the vehicle 100 in two or more previous processes instead of the next process, and may create a control instruction for the vehicle 100 in accordance with the required time. In other words, the remote control unit 210 may create a control instruction to adjust the inter-vehicle distance between the succeeding vehicle of the vehicle 100 and the vehicle 100 in preparation for two or more previous processes. According to this embodiment, the same effects as those of the above-described embodiment can be obtained.

(C2) In the above-described embodiment, the remote control unit 210 creates a control instruction that instructs the second-type vehicle 102 to travel at a speed higher than that of the succeeding vehicle. The remote control unit 210 transmits the second-type vehicle 102 to set the inter-vehicle distance between the second-type vehicle 102 and the succeeding vehicle as a distance D2. The present disclosure is not limited thereto. The remote control unit 210 may create a control instruction instructing the succeeding vehicle to travel at a speed slower than the second-type vehicle 102 and transmit the control instruction to the succeeding vehicle, so that the distance between the second-type vehicle 102 and the succeeding vehicle is set as the distance D2. That is, the remote control unit 210 may create a control instruction that sets the inter-vehicle distance between the second-type vehicle 102 and the succeeding vehicle as the distance D2 with at least one of the second-type vehicle 102 as the preceding vehicle and the succeeding vehicle of the second-type vehicle 102 as the control target. According to this configuration, since the inter-vehicle distance between the second-type vehicle 102 and the succeeding vehicle can be secured, the inter-vehicle distance between the second-type vehicle 102 and the succeeding vehicle can be prevented from being blocked and the succeeding vehicle can be prevented from being stopped, and the traveling of the succeeding vehicle can be prevented from being prevented.

(C3) In the above-described embodiment, the remote control unit 210 creates a control instruction that instructs the second-type vehicle 102 to travel at a speed higher than that of the succeeding vehicle. That is, the remote control unit 210 creates a control instruction for instructing the second-type vehicle 102 to perform a specific speed in accordance with the required time for the process. The present disclosure is not limited thereto. The remote control unit 210 may generate a numerical value, for example, a numerical value such as “+1” or “+2”, indicating the degree of acceleration/deceleration according to the required time of the process as a control instruction, and transmit the generated numerical value to the vehicle 100 together with the normal control instruction. Upon receiving the control instruction, the vehicle control unit 115 controls the actuator group 120 so as to cause the vehicle 100 to travel at a speed obtained by adding speed correction corresponding to a preset amount in accordance with numerical values such as “+1” and “+2” to the traveling speed in the normal state. According to this embodiment, the same effects as those of the above-described embodiment can be obtained.

(C4) In each of the above embodiments, the external sensor 300 is a camera. On the other hand, the external sensor 300 may not be a camera, and may be, for example, a distance measuring device. The distance measuring device may be, for example, a LiDAR (Light Detection And Ranging). In this case, the detection result output by the external sensor 300 may be three-dimensional point cloud data representing the vehicle 100. In this case, the server 200 or the vehicle 100 may acquire the vehicle position information by template matching using three-dimensional point cloud data as a detection result and reference point cloud data prepared in advance.

(C5) In the first embodiment, the server 200 executes processing from acquisition of vehicle position information to generation of a travel control signal. On the other hand, at least a part of the processing from the acquisition of the vehicle position information to the generation of the travel control signal may be executed by the vehicle 100. For example, the following forms (1) to (4) may be used.

(1) The server 200 may acquire the vehicle position information, determine a target position to which the vehicle 100 should be heading next, and generate a route from the current position of the vehicle 100 represented by the acquired vehicle position information to the target position. The server 200 may generate a route to a target position between the current location and the destination, or may generate a route to the destination. The server 200 may transmit the generated route to the vehicle 100. The vehicle 100 may generate a travel control signal so that the vehicle 100 travels on the route received from the server 200, and control the actuator group 120 using the generated travel control signal.

(2) The server 200 may acquire the vehicle position information and transmit the acquired vehicle position information to the vehicle 100. Vehicle 100 may determine a target position to which vehicle 100 should be heading next. The vehicle 100 may generate a route from the current position of the vehicle 100 to the target position represented by the received vehicle position information. The vehicle 100 may generate a travel control signal so that the vehicle 100 travels on the generated route. The vehicle 100 may control the actuator group 120 using the generated travel control signal.

(3) In the above embodiments (1) and (2), an internal sensor may be mounted on the vehicle 100, and a detection result output from the internal sensor may be used for at least one of generation of a route and generation of a travel control signal. The internal sensor is a sensor mounted on the vehicle 100. The internal sensor may include, for example, a sensor that detects a motion state of the vehicle 100, a sensor that detects an operation state of each unit of the vehicle 100, and a sensor that detects an environment around the vehicle 100. Specifically, the inner sensor may include, for example, a camera, a LiDAR, a millimeter-wave radar, an ultrasonic sensor, a GPS sensor, an accelerometer, a gyroscope, and the like. For example, in the embodiment (1), the server 200 may acquire the detection result of the internal sensor and reflect the detection result of the internal sensor in the route when generating the route. In the aspect (1), the vehicle 100 may acquire the detection result of the internal sensor and reflect the detection result of the internal sensor in the travel control signal when generating the travel control signal. In the aspect (2), the vehicle 100 may acquire the detection result of the internal sensor and reflect the detection result of the internal sensor in the route when generating the route. In the aspect (2), the vehicle 100 may acquire the detection result of the internal sensor and reflect the detection result of the internal sensor in the travel control signal when generating the travel control signal.

(4) In the forms (1) to (3), the remote control unit 210 may generate a control instruction or a numerical value together with the created route or the acquired vehicle position information, and may transmit the control instruction or the numerical value to the vehicle 100. The control instruction instructs the traveling speed according to the required time of the process. The numerical value represents the degree of acceleration/deceleration according to the required time of the process.

(C6) In the second embodiment, an internal sensor may be mounted on the vehicle 100v, and a detection result outputted from the internal sensor may be used for at least one of generation of a route and generation of a travel control signal. For example, the vehicle 100v may acquire the detection result of the internal sensor and reflect the detection result of the internal sensor in the route when generating the route. The vehicle 100v may acquire the detection result of the internal sensor and reflect the detection result of the internal sensor in the travel control signal when generating the travel control signal.

(C7) In the above-described embodiment in which the vehicle 100 can travel by autonomous control, the vehicle 100 acquires the vehicle position information using the detection result of the external sensor 300. On the other hand, an internal sensor may be mounted in the vehicle 100. The vehicle 100 may acquire the vehicle position information by using the detection result of the internal sensor. Vehicle 100 may determine a target position to which vehicle 100 should be heading next. The vehicle 100 may generate a route from the current position of the vehicle 100 to the target position represented by the acquired vehicle position information. The vehicle 100 may generate a travel control signal for traveling on the generated route. The vehicle 100 may control the actuator of the vehicle 100 using the generated travel control signal. In this case, the vehicle 100 can travel without using any detection result of the external sensor 300. Note that the vehicle 100 may acquire the target arrival time and the traffic jam information from the outside of the vehicle 100 and reflect the target arrival time and the traffic jam information on at least one of the route and the travel control signal. In addition, all of the functional configurations of the system 10 may be provided in the vehicle 100. That is, the processing implemented by the system 10 in the present disclosure may be implemented by the vehicle 100 alone.

(C8) In the first embodiment, the server 200 automatically generates a travel control signal to be transmitted to the vehicle 100. On the other hand, the server 200 may generate a travel control signal to be transmitted to the vehicle 100 in accordance with an operation of an external operator located outside the vehicle 100. The control device may be operated by an external operator, and the server 200 may generate a travel control signal corresponding to the operation applied to the control device. The control device includes, for example, a display, a steering, an accelerator pedal, a brake pedal, and a communication device. The display is configured to display a captured image output from the external sensor 300. The steering, accelerator pedal, and brake pedal are configured to remotely operate the vehicle 100. The communication device is configured to communicate with the server 200 by wired communication or wireless communication.

(C9) In each of the above-described embodiments, the vehicle 100 may have a configuration that can be moved by unmanned driving, and may be, for example, in the form of a platform having a configuration described below. Specifically, the vehicle 100 is configured to perform three functions of “running,” “turning,” and “stopping” by unmanned driving. The vehicle 100 may include at least a control device that controls the travel of the vehicle 100 and actuators such as a drive device, a steering device, and a braking device. When the vehicle 100 acquires information from the outside for unmanned driving, the vehicle 100 may further include a communication device. That is, the vehicle 100 that can be moved by the unmanned driving may not be equipped with at least a part of an interior component such as a driver's seat or a dashboard. In the vehicle 100, at least a part of an exterior component such as a bumper or a fender may not be attached. The vehicle 100 may not be equipped with a body shell. In this instance, the remaining components, such as the body shell, may be mounted to the vehicle 100 until the vehicle 100 is shipped from the factory FC. The remaining components, such as the body shell, may be mounted to the vehicle 100 after the vehicle 100 is shipped from the factory FC with the remaining components, such as the body shell, not being mounted to the vehicle 100. Each of the components may be mounted from any direction, such as the upper side, lower side, front side, rear side, right side or left side of the vehicle 100, each may be mounted from the same direction, or may be mounted from a different direction. It should be noted that the position determination can also be performed for the form of the platform in the same manner as the vehicle 100 according to the first embodiment.

(C10) The vehicle 100 may be manufactured by combining a plurality of modules. A module refers to a unit composed of one or more components grouped according to the configuration and function of the vehicle 100. For example, the platform of the vehicle 100 may be manufactured by combining a front module, a central module, and a rear module. The front module constitutes the front of the platform. The central module constitutes the central part of the platform. The rear module constitutes the rear of the platform. The number of modules constituting the platform is not limited to three, and may be two or less or four or more. In addition to or instead of the platform, a different part of the vehicle 100 from the platform may be modularized. Further, the various modules may include any exterior parts such as bumpers and grills, and any interior parts such as sheets and consoles. In addition, not only the vehicle 100 but also a moving body of an arbitrary mode may be manufactured by combining a plurality of modules. Such a module may be manufactured, for example, by joining a plurality of parts by welding, a fixture, or the like, or may be manufactured by integrally molding at least a part of the module as one part by casting. Molding techniques for integrally molding at least a portion of a module as one part are also referred to as gigacasts or megacasts. By using the gigacast, each part of the moving body, which has been conventionally formed by joining a plurality of parts, can be formed as one part. For example, the front module, the central module, and the rear module described above may be manufactured using gigacast.

(C11) Transporting the vehicle 100 by using the traveling of the vehicle 100 by the unmanned driving is also referred to as “self-propelled conveyance”. A configuration for realizing self-propelled conveyance is also referred to as a “vehicle remote control autonomous traveling conveyance system”. Further, a production method of producing the vehicle 100 by using self-propelled conveyance is also referred to as “self-propelled production”. In self-propelled manufacturing, for example, at least a part of conveyance of the vehicle 100 is realized by self-propelled conveyance in a factory FC that manufactures the vehicle 100.

(C12) In each of the above-described embodiments, some or all of the functions and processes implemented in software may be implemented in hardware. In addition, some or all of the functions and processes implemented in hardware may be implemented in software. For example, various circuits such as an integrated circuit and a discrete circuit may be used as hardware for realizing various functions in the above-described embodiments.

The present disclosure is not limited to each of the above embodiments, and can be realized by various configurations without departing from the spirit thereof. For example, the technical features in the embodiments corresponding to the technical features in the respective embodiments described in the Summary can be appropriately replaced or combined in order to solve some or all of the above-described problems. For example, the technical features in the embodiments corresponding to the technical features in the respective embodiments described in the Summary can be appropriately replaced or combined in order to achieve some or all of the above-described effects. Further, when the technical features are not described as essential in the present identification, these can be deleted as appropriate.

What is claimed is:

1. A control device that, in a factory for manufacturing a plurality of types of moving bodies in a mixed manner, controls operation of at least part of the types of moving bodies, the control device comprising:
a control instruction creating unit that creates a control instruction for instructing control content to a moving body that is an object of control, wherein
the types of moving bodies include a first-type moving body, and a second-type moving body of which time required for a process set in advance in the factory is longer than that of the first-type moving body,
the control instruction creating unit creates the control instruction so as to adjust an inter-moving-body distance between a preceding moving body and a succeeding moving body following the preceding moving body in a process before entering the process set in advance, and
the control instruction creating unit creates the control instruction such that a second distance that is the inter-moving-body distance when the preceding moving body is the second-type moving body, is greater than a first distance that is the inter-moving-body distance when the preceding moving body is the first-type moving body.

2. The control device according to claim 1, further comprising:
a type information acquisition unit that acquires type information, that is information regarding a type of the moving body; and
an identifying unit that uses the type information to identify a required process time that is time required for completing a task set in advance for the moving body in the process set in advance, wherein the control instruction creating unit creates the control instruction using the required process time.

3. A control device that, in a factory for manufacturing a plurality of types of moving bodies in a mixed manner, controls operation of at least part of the types of moving bodies, the control device comprising:
a control instruction creating unit that creates a control instruction for instructing control content to a moving body that is an object of control, wherein
the types of moving bodies include a first-type moving body, and a second-type moving body of which time required for a process set in advance in the factory is longer than that of the first-type moving body,
the control instruction creating unit creates the control instruction so as to adjust an inter-moving-body distance between a preceding moving body and a succeeding moving body following the preceding moving body in a process before entering the process set in advance, and
the control instruction creating unit creates the control instruction such that a third distance that is the inter-moving-body distance when the succeeding moving body is the second-type moving body, is smaller than a first distance that is the inter-moving-body distance when the succeeding moving body is the first-type moving body.

4. The control device according to claim 3, further comprising:
a type information acquisition unit that acquires type information, that is information regarding a type of the moving body; and
an identifying unit that uses the type information to identify a required process time that is time required for completing a task set in advance for the moving body in the process set in advance, wherein the control instruction creating unit creates the control instruction using the required process time.

5. A system that, in a factory for manufacturing a plurality of types of moving bodies in a mixed manner, controls operation of at least part of the types of moving bodies, the system comprising:
a control instruction creating unit that creates a control instruction for instructing control content to a moving body that is an object of control, wherein
the types of moving bodies include a first-type moving body, and a second-type moving body of which time required for a process set in advance in the factory is longer than that of the first-type moving body,
the control instruction creating unit creates the control instruction so as to adjust an inter-moving-body distance between a preceding moving body and a succeeding moving body following the preceding moving body in a process before entering the process set in advance, and
the control instruction creating unit creates the control instruction such that a second distance that is the inter-moving-body distance when the preceding moving body is the second-type moving body, is greater than a first distance that is the inter-moving-body distance when the preceding moving body is the first-type moving body.
